(19) United States
(12) Patent Application Publication
(10) Pub. No.: US 2013/0032313 A1
(43) Pub. Date: Feb. 7, 2013

(54) HEAT-DISSIPATION UNIT AND METHOD OF MANUFACTURING SAME

(71) Applicants: Chun-Ming Wu, New Taipei City (TW); Ming-Han Yu, New Taipei City (TW)

(72) Inventors: Chun-Ming Wu, New Taipei City (TW); Ming-Han Yu, New Taipei City (TW)

(21) Appl. No.: 13/198,956

(22) Filed: Aug. 5, 2011

(51) Int. Cl. F28D 15/04; B29C 45/14

(52) U.S. Cl. 165/104.26; 264/274

(57) ABSTRACT

A heat-dissipation unit includes a base, at least one heat pipe, and a locating structure. The base has a first face, on which at least one channel is provided. A coupling section is formed on the first face at joints between the at least one channel and the first face. The heat pipe is set in the channel, and the locating structure is correspondingly fitted in the coupling section. In a method of manufacturing the heat-dissipation unit, the locating structure is molded between the at least one heat pipe and the base through a mechanical process, so that the at least one heat pipe is firmly held to the base in a highly efficient assembling manner with largely reduced time and labor to thereby enable reduced manufacturing cost.

### FIELD OF THE INVENTION

The present invention relates to a heat-dissipation unit, and more particularly to a heat-dissipation unit that includes a molded locating structure to ensure increased connection strength between a base and heat pipes thereof, which are preliminarily assembled by way of loose fit. The present invention also relates to a method of manufacturing the above-described heat-dissipation unit at reduced time and labor and increased assembling efficiency.

### BACKGROUND OF THE INVENTION

The currently available heat dissipating devices and thermal modules are formed by assembling a plurality of similar and different heat dissipating elements together. The heat dissipating elements may include heat pipes, heat sinks, heat-dissipating base, etc. These elements are generally assembled together mainly by soldering. However, to solder heat dissipating elements made of an aluminum material, some procedures facilitating soldering must first be executed before specific soldering can be performed to solder the aluminum heat dissipating elements. That is, complicated procedures and high costs are involved in the conventional ways of manufacturing heat dissipating devices. Further, the procedure of soldering would adversely cause environmental pollution.

Some manufacturers also try to assemble different heat dissipating elements together by using fastening elements, such as screws. However, fastening elements like screws can only be used with some types of heat dissipating elements, such as radiating fins and heat-dissipating base. Heat pipes could not be assembled to other heat dissipating elements using screws.

According to the conventional technique, a heat pipe is associated with the heat dissipating base by forming a hole or a channel on the heat dissipating base and extending the heat pipe through the hole or the channel. In this manner, while the heat pipe can be associated with the heat dissipating base without using screws, heat is indirectly transferred to the heat pipe via the base and the condition of thermal resistance tends to occur due to the clearance existing between the heat pipe and the base. All these factors result in poor heat transfer efficiency of the finally formed heat dissipating device or thermal module.

That is, the conventional techniques for assembling different heat dissipating elements together to form a thermal module or a heat dissipating device have the following disadvantages: (1) requiring high manufacturing cost; (2) not adaptable to all kinds of heat dissipating elements; (3) causing environmental pollution; (4) having poor heat transfer efficiency; (5) being heavy in weight; and (6) having low production yield.

### SUMMARY OF THE INVENTION

A primary object of the present invention is to provide a heat-dissipation unit that includes a base and other heat-dissipation elements being assembled to one another in an efficient manner.

Another object of the present invention is to provide a method of manufacturing a heat-dissipation unit, so that a base and other heat-dissipation elements of the heat-dissipation unit are assembled to one another in an efficient manner.

To achieve the above and other objects, the heat-dissipation unit according to the present invention includes a base, at least one heat pipe, and a locating structure. The base has a first face, on which at least one channel is provided. The channel has an open side and a closed side. A coupling section is formed at joints of the at least one channel and the first face. The heat pipe is set in the channel and has one surface being flush with the first face of the base. The locating structure is correspondingly fitted in the coupling section.

To achieve the above and other objects, the method of manufacturing heat-dissipation unit according to the present invention includes the following steps:

providing a base and at least one heat pipe, and the base having at least one channel provided thereon;

correspondingly setting the at least one heat pipe in the at least one channel;

positioning the assembled heat pipe and base in a cavity of a mold; and

using a mechanical process to inject a molten plastic material into the mold to fill joints of a top of the at least one channel and the at least one heat pipe, and waiting until the molten plastic material is cooled and set to form a molded locating structure that firmly holds the at least one heat pipe to the base.

With the heat-dissipation unit and the method of manufacturing same according to the present invention, it is able to assemble the heat pipe to the base without the need of using additional fastening elements. Therefore, the heat-dissipation unit can be manufactured in largely increased efficiency and at reduced time and labor costs.

In brief, the present invention provides the following advantages: (1) reduced manufacturing costs; (2) meeting the requirement for environmental protection; (3) light in weight; (4) high production yield.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1a is an exploded perspective view of a heat-dissipation unit according to a first embodiment of the present invention;

FIG. 1b is an assembled view of FIG. 1;

FIG. 2a is an exploded perspective view of a heat-dissipation unit according to a second embodiment of the present invention;

FIG. 2b is an assembled view of FIG. 2a;

FIG. 3a is an exploded perspective view of a heat-dissipation unit according to a third embodiment of the present invention;

FIG. 3b is an assembled view of FIG. 3a;

FIG. 4 is a sectional view of a heat-dissipation unit according to a fourth embodiment of the present invention;

FIG. 5 is a sectional view of a heat-dissipation unit according to a fifth embodiment of the present invention;

FIG. 6 is a sectional view of a heat-dissipation unit according to a sixth embodiment of the present invention;

FIG. 7 is an exploded perspective view of a heat-dissipation unit according to a seventh embodiment of the present invention;

FIG. 8 is a flowchart showing the steps included in a method of manufacturing heat-dissipation unit according to an embodiment of the present invention; and

FIG. 9 illustrates the heat-dissipation unit manufacturing method of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

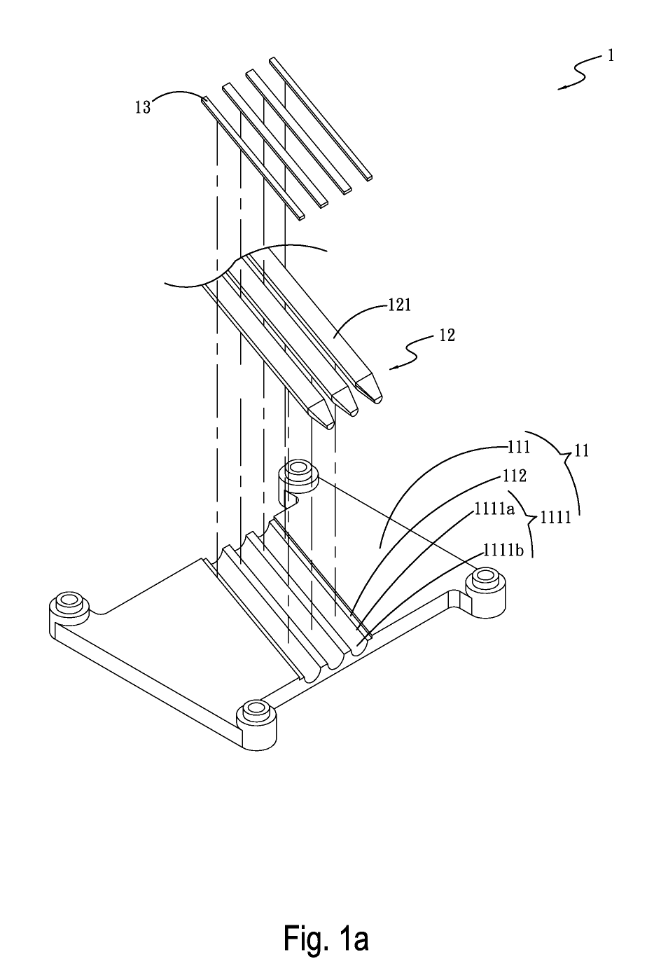

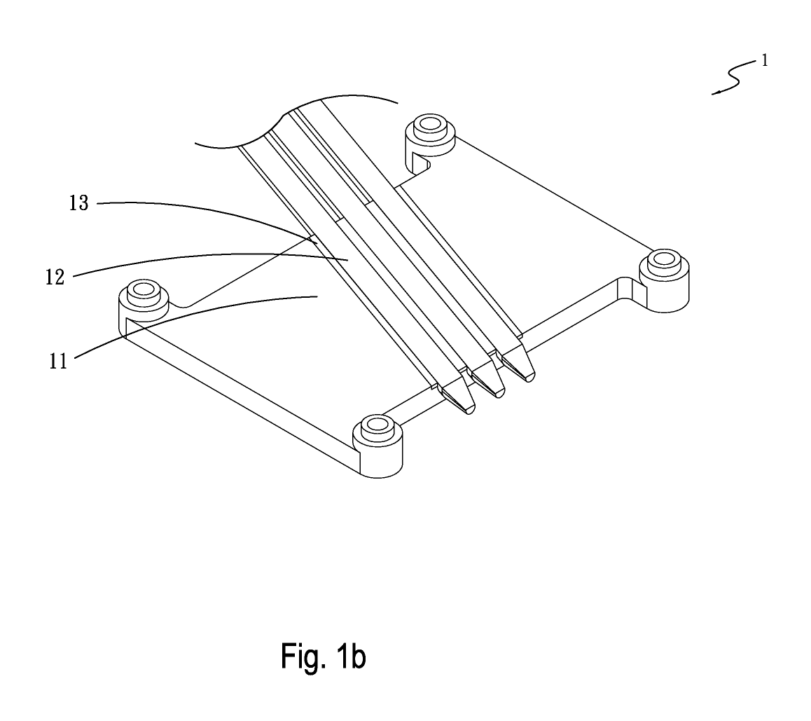

Please refer to FIGS. 1a and 1b that are exploded and assembled perspective views, respectively, of a heat-dissipation unit 1 according to a first embodiment of the present invention. As shown, the heat-dissipation unit 1 includes a base 11, at least one heat pipe 12, and a locating structure 13.

The base 11 has a first face 111, on which at least one channel 1111 is provided. The channel 1111 has an open side 1111a and a closed side 1111b, and a coupling section 112 is formed on the first face 111 at joints of the at least one channel 1111 and the first face 111. In the first embodiment, the coupling section 112 is extended in a direction parallel with the channel 1111.

The heat pipe 12 is set in the channel 1111, and has one surface 121 being flush with the first face 111 of the base 11.

The locating structure 13 is correspondingly fitted in the coupling section 112, and has one side in contact with the heat pipe 12.

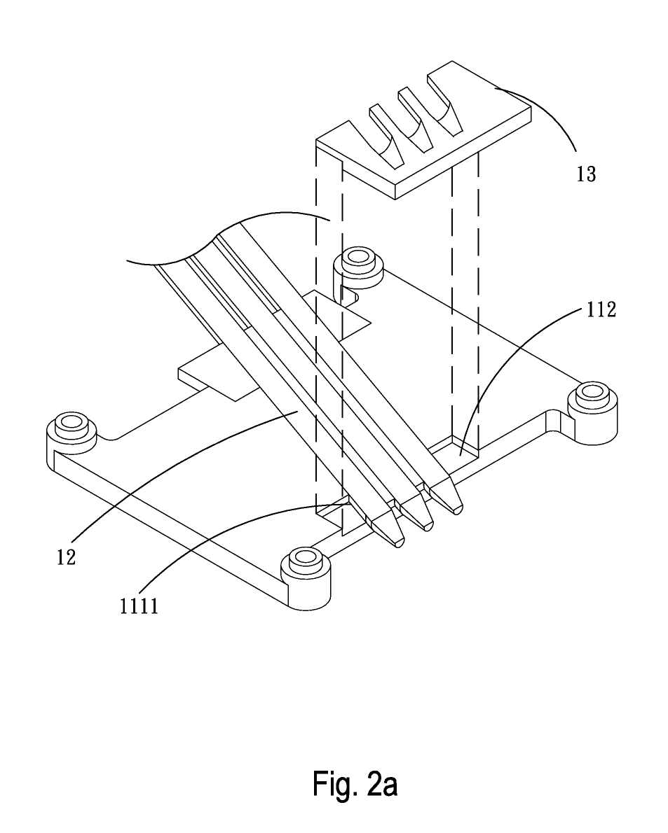

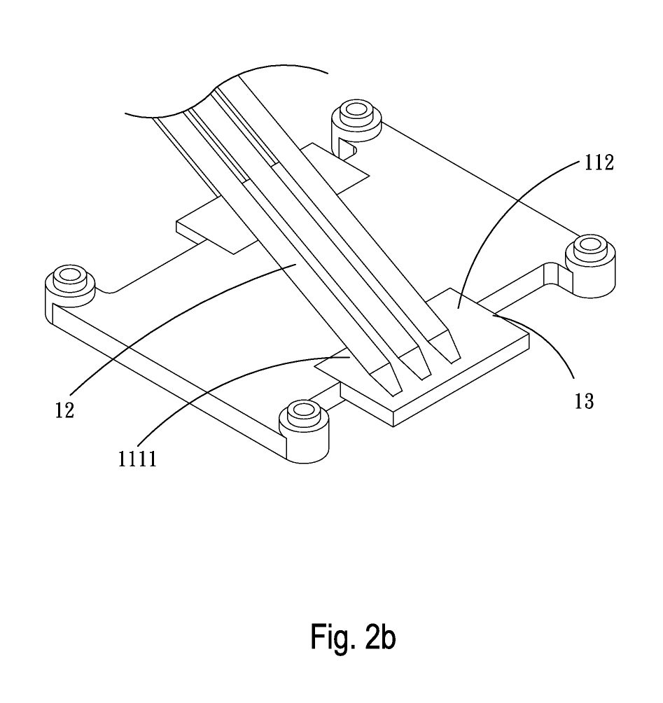

Please refer to FIGS. 2a and 2b that are exploded and assembled perspective views, respectively, of a heat-dissipation unit according to a second embodiment of the present invention. As shown, the second embodiment is generally structurally similar to the first embodiment, except that, in the second embodiment, the coupling section 112 is extended in a direction perpendicular to the channel 1111 and the locating structure 13 is correspondingly fitted in the coupling section 112 to hold the heat pipe 12 in place.

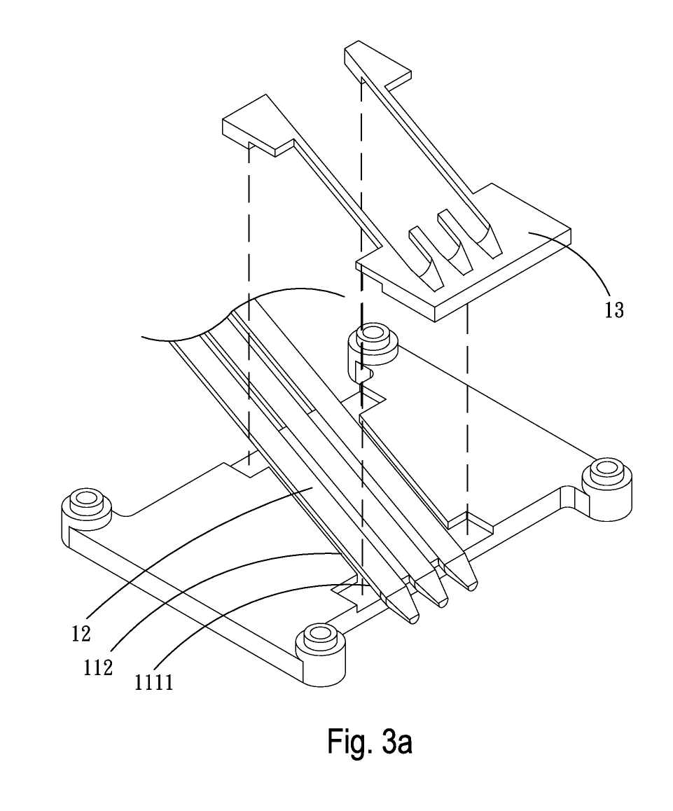

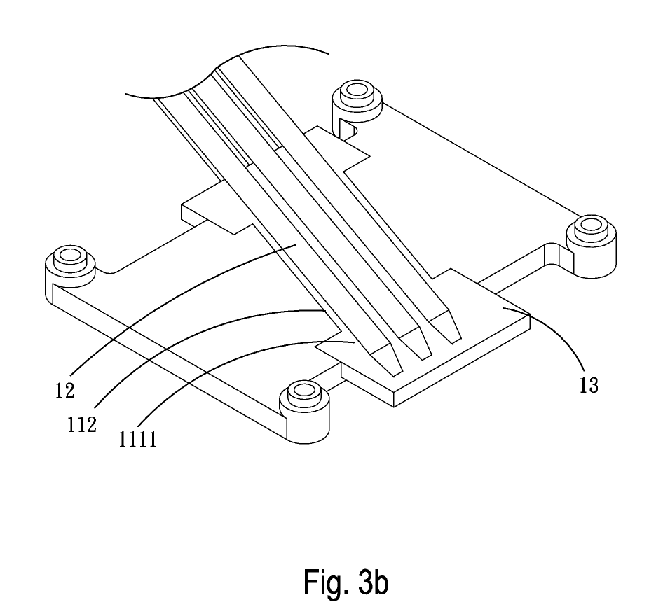

FIGS. 3a and 3b are exploded and assembled perspective views, respectively, of a heat-dissipation unit according to a third embodiment of the present invention. As shown, the third embodiment is generally structurally similar to the first embodiment, except that, in the third embodiment, the coupling section 112 is extended in two directions to be parallel with and perpendicular to the channel 1111 at the same time, and the locating structure 13 is correspondingly fitted in the coupling section 112 to hold the heat pipe 12 in place.

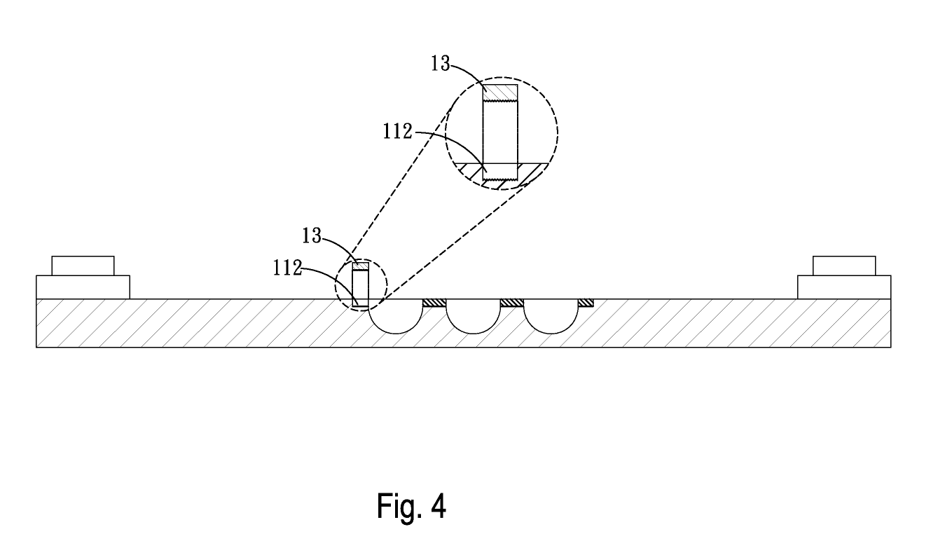

FIG. 4 is a sectional view of a heat-dissipation unit according to a fourth embodiment of the present invention. As shown, the fourth embodiment is generally structurally similar to the first embodiment, except that, in the fourth embodiment, the coupling section 112 has a roughened surface and an area of the locating structure 13 correspondingly contacting with the coupling section 112 also has a roughened surface. With these roughened surfaces, increased connection strength between the locating structure 13 and the coupling section 112 can be obtained.

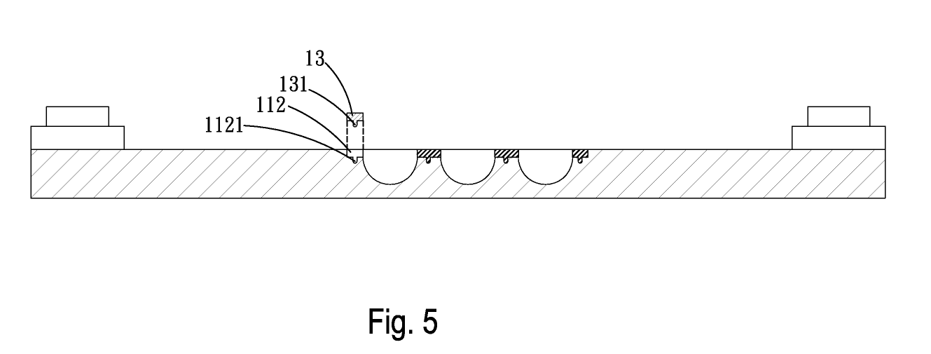

FIG. 5 is a sectional view of a heat-dissipation unit according to a fifth embodiment of the present invention. As shown, the fifth embodiment is generally structurally similar to the first embodiment, except that, in the fifth embodiment, the coupling section 112 is provided with at least one hole 1121, which can be a through hole or a blind hole, and the locating structure 13 is provided with at least one protrusion 131 corresponding to the hole 1121 for fixedly fitting in the hole 1121.

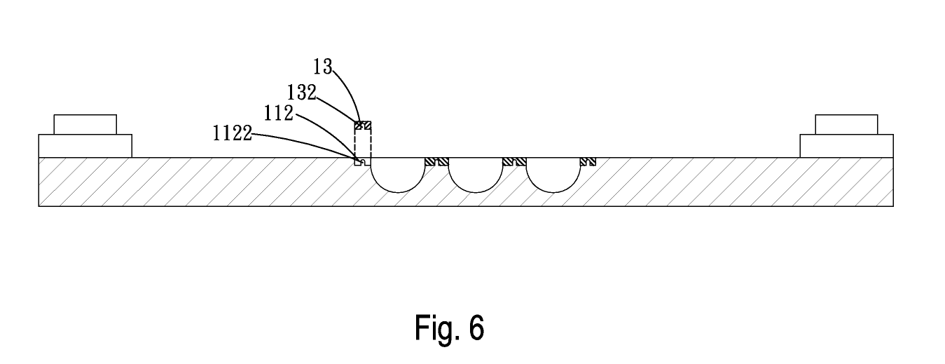

FIG. 6 is a sectional view of a heat-dissipation unit according to a sixth embodiment of the present invention. As shown, the sixth embodiment is generally structurally similar to the first embodiment, except that, in the sixth embodiment, the coupling section 112 is provided with at least one protrusion 1122, and the locating structure 13 is provided with at least one hole 132, which can be a through hole or a blind hole, corresponding to the protrusion 1122 for fixedly receiving the protrusion 1122 therein.

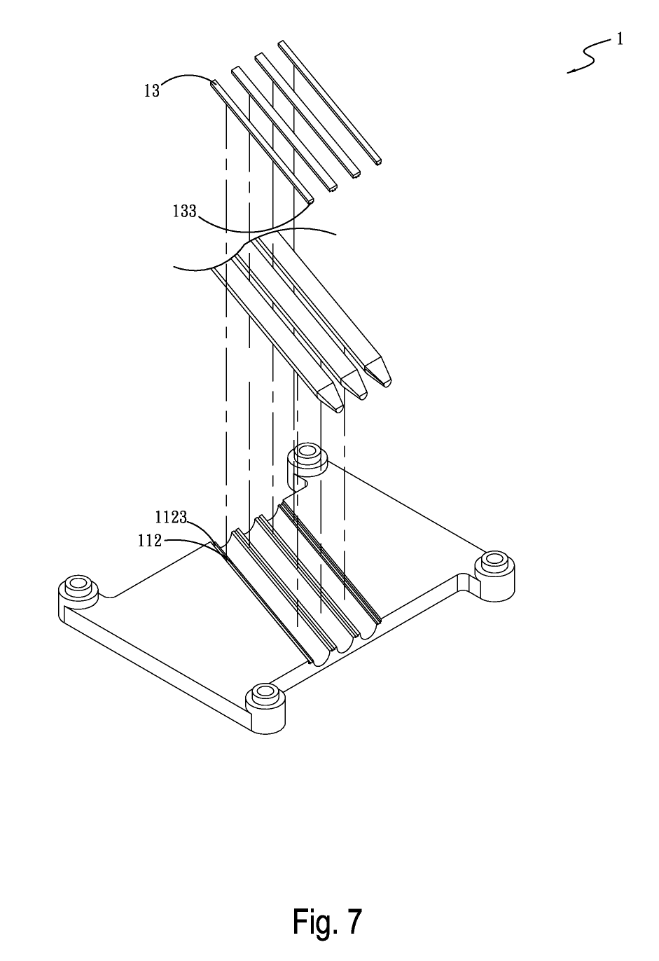

Please refer to FIG. 7 that is an exploded perspective view of a heat-dissipation unit 1 according to a seventh embodiment of the present invention. As shown, the seventh embodiment is generally structurally similar to the first embodiment, except that, in the seventh embodiment, the coupling section 112 is provided with at least one groove 1123, which can have an open bottom or a closed bottom, and the locating structure 13 is provided with at least one rib 133 corresponding to the groove 1123 for fixedly fitting in the groove 1123.

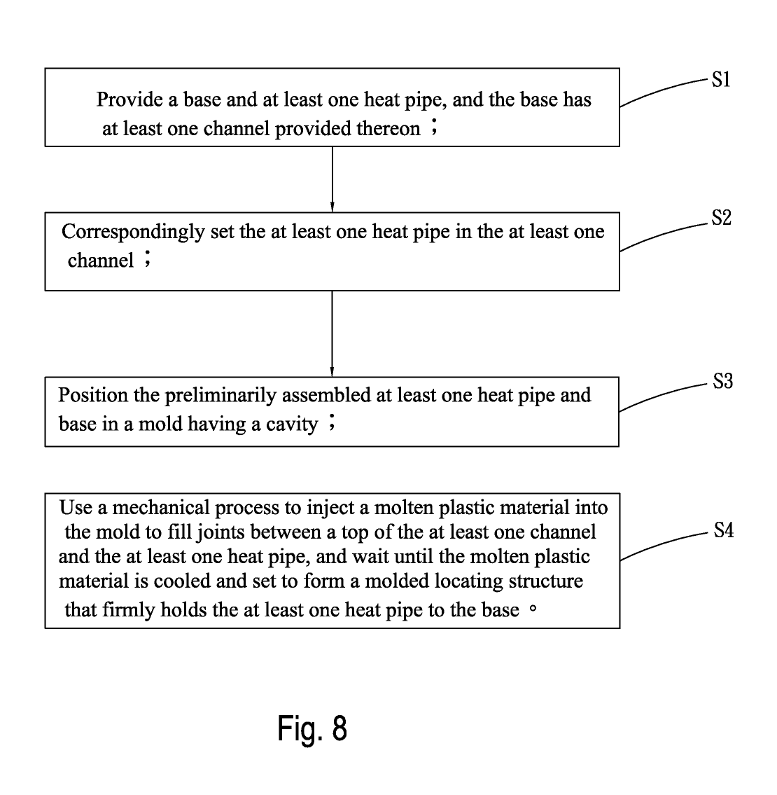

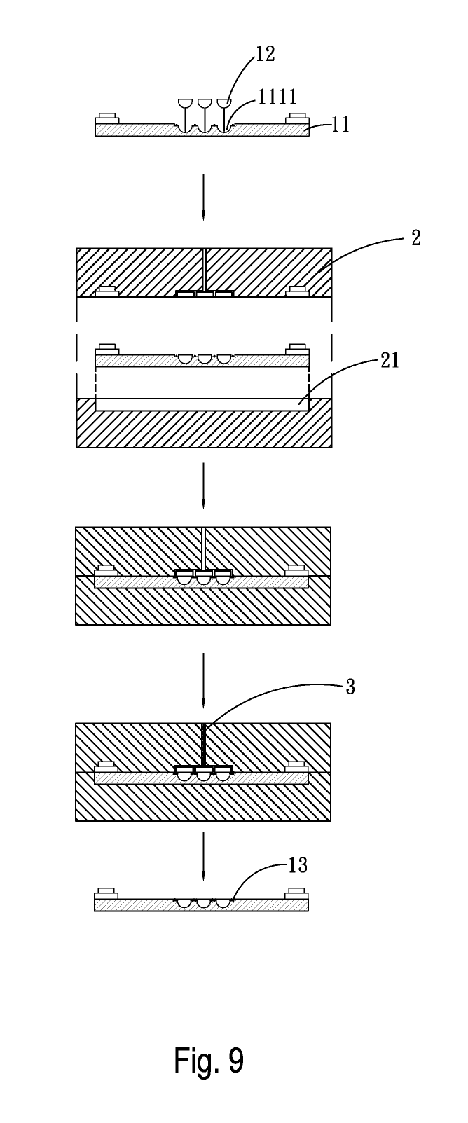

FIG. 8 is a flowchart showing four steps S1˜S4 included in a heat-dissipation unit manufacturing method according to an embodiment of the present invention, and FIG. 9 illustrates the manufacturing method of FIG. 8. Please refer to FIGS. 8 and 9 along with FIGS. 1a and 1b.

In a first step S1, a base, which is provided with at least one channel, and at least one heat pipe are provided.

More specifically, a base 11 with at least one channel 1111 and at least one heat pipe 12 are provided. The base 11 can be made of a metal material with good heat conductivity, such as copper or aluminum, or a non-metal material, such as a plastic material, without particular limitation thereto.

In a second step S2, the heat pipe is correspondingly set in the channel.

More specifically, the at least one heat pipe 12 is correspondingly set in the at least one channel 1111 on the base 11.

In a third step S3, an assembly of the base and the heat pipe is positioned in a mold having a cavity.

More specifically, the preliminarily assembled base and heat pipe are positioned in a cavity 21 of a mold 2, and the mold 2 is then closed.

Finally, in a fourth step S4, by way of a mechanical process, a molten plastic material is injected into the mold to fill joints of a top of the channel and the heat pipe, and then wait until the molten plastic material is cooled and set to form a molded locating structure that firmly holds the heat pipe to the base.

More specifically, a molten plastic material 3 is injected into the mold 2 by way of injection molding, so as to fill joints of the at least one channel 1111 on the base 11 and the at least one heat pipe 12 (i.e. fill the coupling section 112 with a plastic material 3). When the molten plastic material 3 is cooled and set, a molded locating section 13 is formed to firmly hold the at least one heat pipe 12 to the base 11, ensuring increased connection strength between the heat pipe 12 and the base 11. By “mechanical process”, it means injection molding.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A heat-dissipation unit, comprising:
a base having a first face, on which there being provided at least one channel having an open side and a closed side as well as a coupling section located at joints of the at least one channel and the first face;
at least one heat pipe being set in the at least one channel with one surface flush with the first face of the base; and
a locating structure being correspondingly fitted in the coupling section.

2. The heat-dissipation unit as claimed in claim 1, wherein the coupling section has a roughened surface and an area of the locating structure correspondingly contacting with the coupling section also has a roughened surface.

3. The heat-dissipation unit as claimed in claim 1, wherein the coupling section is provided with at least one hole, and the locating structure is provided with at least one protrusion corresponding to the at least one hole for fixedly fitting in the at least one hole.

4. The heat-dissipation unit as claimed in claim 3, wherein the hole can be any one of a through hole and a blind hole.

5. The heat-dissipation unit as claimed in claim 1, wherein the coupling section is provided with at least one protrusion, and the locating structure is provided with at least one hole corresponding to the at least one protrusion for fitly receiving the at least one protrusion therein.

6. The heat-dissipation unit as claimed in claim 5, wherein the hole can be any one of a through hole and a blind hole.

7. The heat-dissipation unit as claimed in claim 1, wherein the locating structure has one side in contact with the at least one heat pipe.

8. The heat-dissipation unit as claimed in claim 1, wherein the coupling section is configured in a manner selected from the group consisting of extending in a direction parallel with the channel, extending in a direction perpendicular to the channel, and extending in two directions to be parallel with and perpendicular to the channel at the same time.

9. A method of manufacturing heat-dissipation unit, comprising the following steps:
providing a base and at least one heat pipe, and the base having at least one channel provided thereon;
correspondingly setting the at least one heat pipe in the at least one channel;
positioning the preliminarily assembled heat pipe and base in a cavity of a mold; and
using a mechanical process to inject a molten plastic material into the mold to fill joints of a top of the at least one channel and the at least one heat pipe, and waiting until the molten plastic material is cooled and set to form a molded locating structure that firmly holds the at least one heat pipe to the base.

10. The heat-dissipation unit manufacturing method as claimed in claim 9, wherein the mechanical process is injection molding.

11. The heat-dissipation unit manufacturing method as claimed in claim 9, wherein the base is made of a material selected from the group consisting of a metal material and a non-metal material.

12. The heat-dissipation unit manufacturing method as claimed in claim 11, wherein the metal material is selected from the group consisting of copper and aluminum.

13. The heat-dissipation unit manufacturing method as claimed in claim 11, wherein the non-metal material is a plastic material.
